(19) United States
(12) Patent Application Publication
(10) Pub. No.: US 2001/0036291 A1
(43) Pub. Date: Nov. 1, 2001

(54) Voice conveying guide tube for headsets

(75) Inventor: Fabrizio Pallai, Milano (IT)

Correspondence Address: BRINKS HOFER GILSON & LIONE, P.O. BOX 10395, CHICAGO, IL, 60610, US

(73) Assignee: SILICOMO SPA.

(21) Appl. No.: 09/803,158

(22) Filed: Mar. 9, 2001

(30) Foreign Application Priority Data
Apr. 28, 2000 (EP) 00830317.4

(51) Int. Cl. H04R 25/00

(52) U.S. Cl. 381/382; 381/370

(57) ABSTRACT

A voice conveying guide tube for headsets, comprising a hollow tubular element (24; 100) able to convey voice from the user's mouth to an earpiece assembly (3) of the headset (1) in which a transducer or microphone (60) able to convert the acoustic signal to an electrical signal is provided; the tubular element being flexible so that it can be bent into the desired position and comprising means (71; 102) able to maintain it in the position into which it has been bent.

### DESCRIPTION

The present invention refers to a voice conveying guide tube for headsets.

The voice conveying guide tube, commonly known as a voice tube, is a hollow tube which allows the operator's voice to be carried from his mouth toward a microphone which is normally positioned inside an earpiece of the headset.

Currently known for this purpose are metal tubes mounted in an articulated manner on an earpiece of the headset so that they can be moved by the user in order to adapt them to particular requirements. A ball joint between the voice tube and a support on the earpiece allows rotary movement of the voice tube and a telescopic joint allows translation of the voice tube.

It is obvious that this solution proves extremely complex and costly because of the ball joint and the telescopic joint of the voice tube and for this reason the voice tube is mounted permanently in the headset and used for the entire life of the headset.

For this reason, besides being complex and costly, this solution is unhygienic, especially when different operators are obliged to use the same headset. In fact the voice tube is a part that comes into close contact with the user's mouth with the resulting transmission of germs from voice tube to mouth and vice versa. For this reason increasing use is made on the market of disposable headsets which are thrown away after use and not recycled for another user. However, because lower quality materials are used, these disposable headsets do not have the same characteristics as reusable headsets and in any case are economically disadvantageous in the end.

The object of the invention is to solve the problems illustrated above, providing a voice tube for headsets that is practical, versatile, economical, easy to make and can be removably mounted on the headset so that it can be replaced as required.

This object is achieved according to the invention with the characteristics listed in appended independent claim 1.

Preferred embodiments of the invention are apparent from the dependent claims.

The voice tube according to the invention provides a hollow tubular element which is assembled directly on the earpiece assembly of the headset without any articulated joint, such as a ball joint or a telescopic joint, being provided. The tubular element is made of a suitable material which can be deformed by the operator. Said tubular element, once deformed, is able to maintain the desired shape of deformation. Thus the operator can bend the voice tube according to his own needs, directing it towards his own mouth and the guide tube maintains this position until the next deformation.

The voice tube is removably coupled to the earpiece element of the headset through pressure, and engagement and disengagement of the voice tube from the earpiece assembly of the headset is extremely simple for the user. In this manner, once the voice tube has been used, it can be disengaged from the headset and replaced with a new voice tube. Consequently the voice tube according to the invention fully satisfies the required hygienic standards.

The voice tube according to the invention can be produced and sold separately from the headset. Consequently a variety of voice tubes of different colours, obtained through chromatically different coating materials, can be put onto the market. Thus the user can choose the colour of the voice tube as desired, according to his own aesthetic preference, and reuse it every time he uses a headset shared by other operators, uniquely distinguishing it from other voice tubes.

Further characteristics of the invention will be made clearer by the detailed description that follows, referring to purely exemplary and therefore non-limiting embodiments thereof, illustrated in the appended drawings, in which:

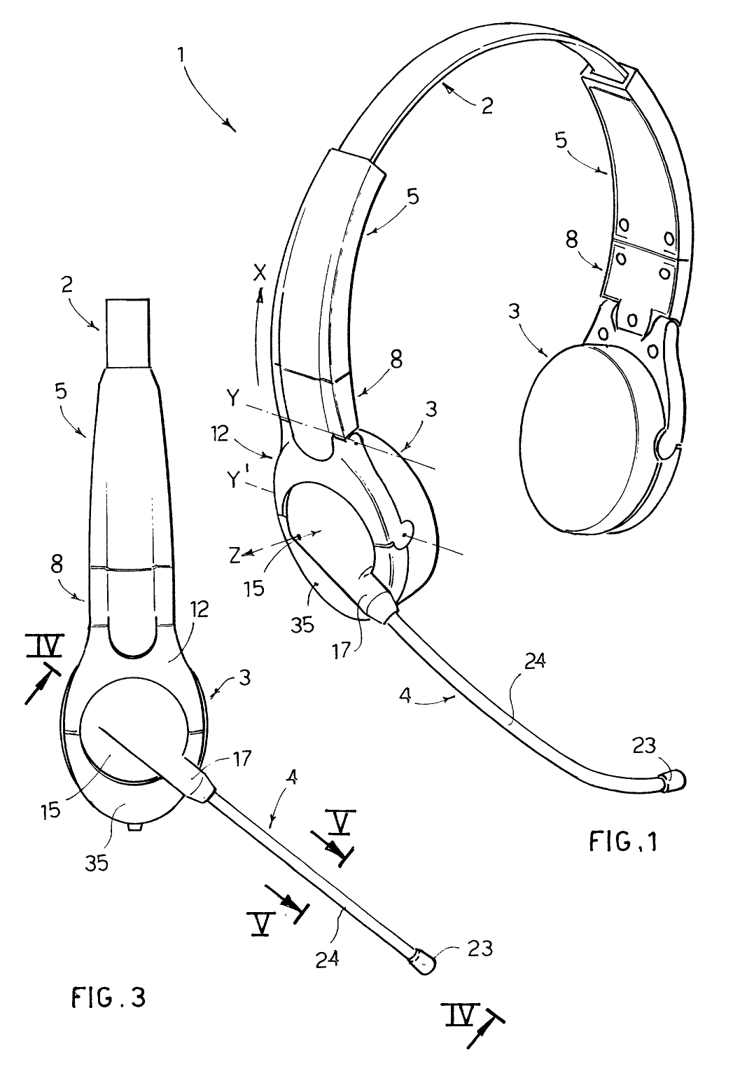

FIG. 1 is a perspective view of a voice tube according to the invention, applied to a headphone;

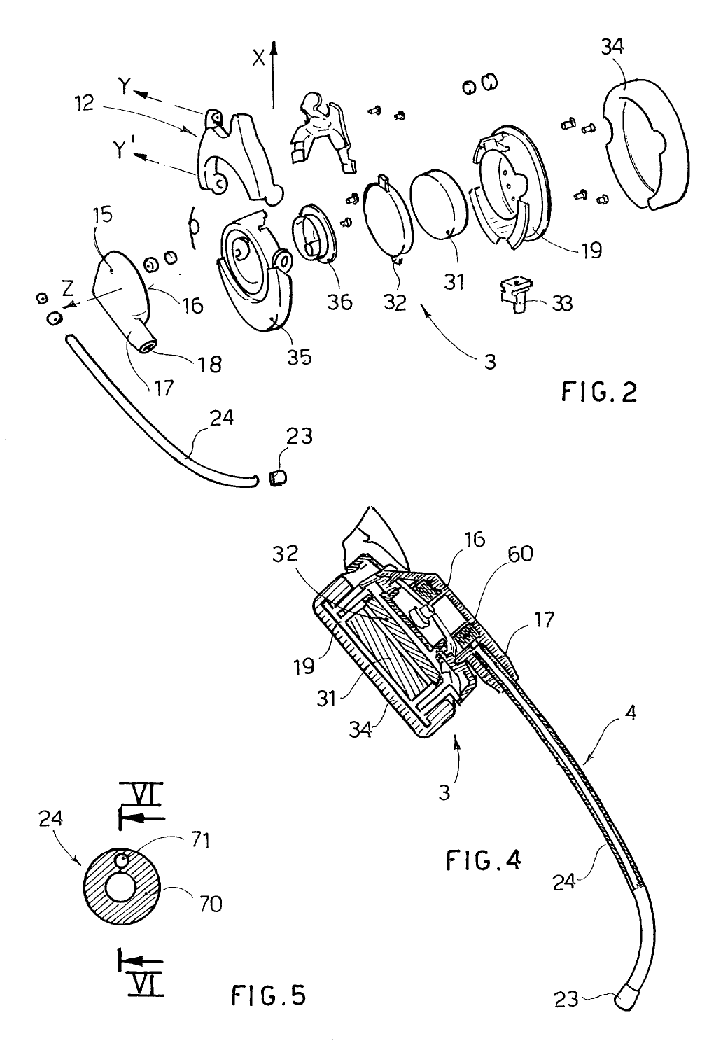

FIG. 2 is an exploded view of an earpiece assembly and of the voice tube;

FIG. 3 is a side view of a detail of FIG. 1, showing the earpiece assembly with the voice tube assembled;

FIG. 4 is an axial section, along the line IV-IV of FIG. 3, showing the voice tube according to a first embodiment of the invention, applied to the earpiece assembly of the headset;

FIG. 5 is an enlarged cross section of the voice tube according to the first embodiment of the invention, taken along the line V-V of FIG. 2;

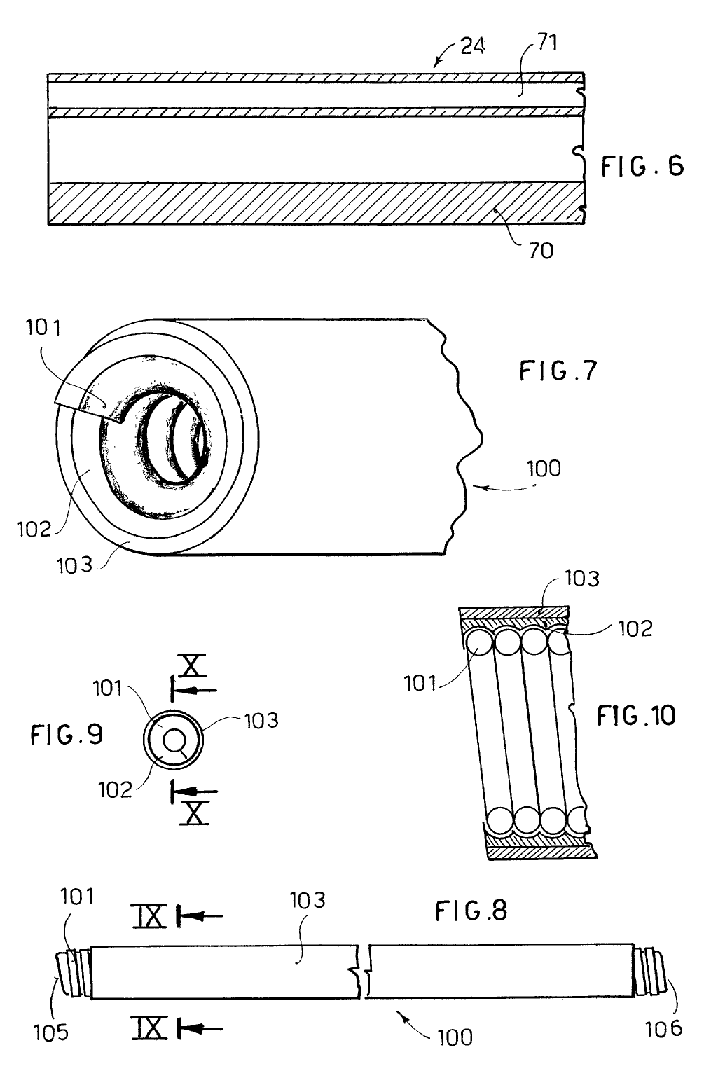

FIG. 6 is a partially broken away longitudinal section along the line VI-VI of FIG. 5;

FIG. 7 is an axonometric view, enlarged and broken away, of a voice tube according to a second embodiment of the invention;

FIG. 8 is a plan view, partially broken away, of the voice tube according to the second embodiment;

FIG. 9 is a cross section along the line IX-IX in FIG. 8;

FIG. 10 is an enlarged longitudinal section, partially broken away, along the line X-X in FIG. 9.

A first embodiment of the invention will now be described with the aid of FIGS. 1-6. FIG. 1 shows a headset, indicated as a whole with reference numeral 1. The headset 1 comprises an elastic headband 2 on which two earpiece elements 3 are assembled. A voice tube 4 is assembled on one of the two earpiece elements to convey voice from the user's mouth to the earpiece element 3.

The ends of the elastic headband 2 are mounted telescopically inside a guide 5. The guide 5 is hinged in an intermediate element 8 so that the intermediate element 8 is free to turn around an axis X with respect to the guide. The intermediate element 8 is hinged to a fork 12, so that the fork 12 can turn around an axis Y substantially at right angles to the axis X.

The fork 12 supports the earpiece assembly 3. As shown in FIG. 2, the earpiece assembly 3 comprises an electroacoustic transducer 31 to convert the electrical signal to an acoustic signal which is heard through the earpiece assembly 3. The electroacoustic transducer 31 is inserted in a transducer holder 19 covered by a cover 32 formed by a printed circuit board. A connector 33 with an electrical cable for conveying the electrical signals is assembled on the transducer holder 19. The transducer holder 19 is covered by a foam covering 34 destined to come into contact with the user's ear. The transducer holder 19 is fixed to an annular support 35 which is hinged to the fork 12, so that the annular support 35 can turn around an axis Y′ substantially parallel to the axis Y. In this manner the intermediate element 8 and the fork element 12 form a pantograph with respect to the earpiece element 3 which is articulated with respect to the guide 5.

The voice tube assembly 4 comprises a hollow tubular element 24 which is assembled to a cover 15. The cover 15 comprises a circular plate 16 provided with a tang 17 which has a hole 18 wherein the hollow tube 24 is engaged by pressure. In this manner, through coupling and uncoupling by pressure, replacement of the voice tube proves extremely simple.

A substantially cylindrical cap 23 is inserted in the free end of the tubular element 24 purely for aesthetic purposes. The cover 15 is mounted rotatably on the annular support 35 so that it can turn around the axis Z of the circular plate 16. A spring ring 36 is interposed between the cover 15 and the annular support 35 to regulate rotation of the cover 15. In this manner the tubular element 24 can be regulated so that its end 23 is brought near to the user's mouth.

As shown in FIG. 4, inside the circular plate 16 of the cover 15 is a transducer or microphone 60 able to convert the acoustic signal coming from the tube 24 to an electrical signal which is sent toward the output of the headset. The transducer 60 can clearly be inserted in any part of the earpiece assembly 3.

As shown in FIGS. 5 and 6, the voice tube 24 is made by coextrusion of a plastic material 70 and a metal core 71. The plastic material 70 is extruded so as to have a hollow tube with an inside diameter of about 1.5 mm and an outside diameter of about 3.5 mm. The metal core 71 is a thin metal wire with a diameter of less than about 2 mm which is coextruded with the plastic material 70 so as to be in an eccentric position and substantially parallel with respect to the axis of the voice tube 24. The metal core 71 is preferably completely covered with plastic material 70 and remains inside the thickness of the tube.

The plastic material 70 is a flexible plastic material. A transparent plastic material such as polyethylene, for example, is preferably used. The metal core 71 is made of a substantially rigid metal which can be easily bent and maintain the bent shape. The metal core 71 can preferably be made of steel wire.

In this manner the voice tube 24 can be bent by the user into any position suitable to bring the end 23 of the voice tube 24 near to the user's mouth and the voice tube 24 maintains said desired position until a subsequent bending.

A second embodiment of a voice tube 100 according to the invention will now be described with the aid of FIGS. 7-10. The voice tube 100 comprises a metal coil spring 101 which is wound in a coil so as to form a hollow tube with an outside diameter of about 3.2 mm and an inside diameter of about 1.2 mm. The coil spring 101 is coated on the outside with a layer of malleable metal material 102.

When the spring 101 is bent, the gaps present between the outer surface of the coils of the spring are caused to widen. These widened gaps are filled by the malleable metal material 102 which ensures that the bent position of the coil spring 101 is maintained. In this manner the coil spring 101 can be bent into the desired position and, thanks to the presence of the layer of malleable metal material 102, it maintains this position.

The coil spring 101 is preferably made of steel and the layer 102 of bronze. The malleable layer 102 can in turn be coated with a sheath 103 of transparent or coloured plastic material. The coating sheath 103 is preferably made of heat-shrinkable material such as polyolefin.

As shown in FIG. 8, the two ends 105 and 106 of the voice tube 100 are bare so that the end 106 can be inserted by pressure into a hole provided in an earpiece assembly of an acoustic headphone, such as the hole 16 in the tang 17 of the cover 15 according to the first embodiment. The other end 105 of the voice tube 100, on the other hand, can accommodate a cap similar to the cap 23 described in the first embodiment.

The voice tube 24 according to the first embodiment and the voice tube 100 according to the second embodiment can in any case be applied to other types of headset having other types of earpiece assemblies, by means of any type of removable assembly, which allows coupling and uncoupling to be achieved simply by the user.

Changes and modifications of detail within the reach of an expert in the field can be made to the present embodiments, without departing from the scope of the invention as set forth in the appended claims.

1. A voice conveying guide tube for headsets, comprising a hollow tubular element (24; 100) able to carry voice from the user's mouth to an earpiece assembly (3) of the headset (1) wherein a transducer or microphone (60) able to convert the acoustic signal to an electric signal is provided, characterized in that said tubular element (24; 100) is flexible, in order to be able to bent into the desired position and comprises means (71; 102) able to maintain it in the position into which it has been bent.

2. A voice conveying guide tube according to claim 1, characterized in that said tubular element (24) is a tube (70) of flexible plastic material and said means able to maintain the tubular element in the position into which it has been bent are a substantially rigid core (71).

3. A voice conveying guide tube according to claim 2, characterized in that said core (71) is disposed in the thickness of said tube (70) in an eccentric position, substantially parallel to the axis of said tubular element (24).

4. A voice conveying guide tube according to claim 2 or 3, characterized in that said core (71) is made of a steel wire.

5. A voice conveying guide tube according to any one of claims 2 to 4, characterized in that said tubular element (24) is made by means of coextrusion of said tube of plastic material (70) and said core (71).

6. A voice conveying guide tube according to claim 2 or 5, characterized in that said tubular element (24) is made of transparent plastic material (70).

7. A voice conveying guide tube according to claim 1, characterized in that said tubular element (24) is made by means of a coil spring (101) and said means destined to maintain the tubular element in the position into which it has been bent are a layer (102) of malleable metal material disposed on the outer surface of said coil spring (101).

8. A voice conveying guide tube according to claim 7, characterized in that said coil spring (101) is made of steel and said layer (102) coating the outer surface of the coil spring (101) is made of brass-based metal material.

9. A voice conveying guide tube according to claim 7 or 8, characterized in that said layer (102) coating the coil spring is covered by a sheath (103) of heat-shrinkable plastic material.

10. A voice conveying guide tube according to any one of the preceding claims, characterized in that said tubular element (24; 100) is mounted by pressure fitting of one of its ends into a hole (18) made in a cover (15) of said earpiece assembly (3).

11. A voice conveying guide tube according to claim 10, characterized in that said cover (15) is rotatably mounted on said earpiece assembly (3).

12. A headset (1), comprising at least one earpiece assembly (3) destined to be positioned near the user's ear, characterized in that it provides a voice conveying guide tube according to any one of the preceding claims, able to convey voice from the user's mouth to said earpiece assembly.
